(19) United States
(12) Patent Application Publication
(10) Pub. No.: US 2016/0311101 A1
(43) Pub. Date: Oct. 27, 2016

(54) CABLE COUNTERSINK TOOL

(71) Applicant: Thomas Sturkenboom, Williamstown (CA)

(72) Inventor: Thomas Sturkenboom, Williamstown (CA)

(21) Appl. No.: 14/692,671

(22) Filed: Apr. 21, 2015

(51) Int. Cl. B25D 1/00

(52) U.S. Cl. CPC B25D 1/00

(57) ABSTRACT

A cable countersink tool has a handle, a stop mounted at the end of the handle for providing resistance when penetrating a workpiece, and a blunt tip projecting from the stop for engaging a cable and countersinking it within the workpiece, wherein the tip is adapted to pushing the cable beneath the surface of the workpiece and the stop controls the depth to which the tip penetrates within the workpiece. In a further embodiment a cable countersink tool has a handle, a rod projecting from the handle; and a first arm and a second arm mounted on the rod to form a right angle relative to one another, the arms for engaging a cable and countersinking it within an angular workpiece, wherein the first and second arms are adapted to push the cable beneath the surface of the workpiece.

### FIELD

The invention relates to tools used to countersink cable within construction materials.

### BACKGROUND

During construction of a building, the walls of the building are insulated to protect the occupants from temperature differences outside. Typically, the insulation consists of foam panels or fiberglass batten. Cables are routed throughout the building to provide electricity and data signals to the occupants. Under building codes, cable and wire must be located within the insulation rather than laid over the surface.

One means for locating the cable within insulation has been to countersink it within the building materials by pushing the cable or wire in. In order to countersink the cable below the surface of the insulation, in the past contractors have used flathead screwdrivers to push the cable beneath the surface. Screwdriver heads can cause cuts to contractors especially when pushed forcefully to deposit the cable under the surface of the insulation. In addition, the wire may roll out of one side of the screwdriver blade, requiring a contractor to push several times to countersink the cable. Each push needlessly damages the insulation. This problem is exacerbated with two cables at the same time, where the cables may each roll to a separate side of the screwdriver blade. Also, there is no stop on a screwdriver to determine the depth of the cable once countersunk, and the cable depth is estimated by the contractor as he or she countersinks the cable. This leads to non-uniform cable depth and may breach the building code. Further, the problem also exists in pushing the cable into a uniform depth in corners, which is very awkward using a screwdriver and may result in non-compliance with the building code.

Therefore there is a need for a tool for countersinking cables that prevents the cable from slipping to the side of the tools when pressure is applied, and is able to control the depth of the countersinking of the cable, so as to maintain a uniform depth throughout the job.

### SUMMARY

A cable countersink tool is described, having a handle, a stop mounted at the end of the handle for providing resistance when penetrating a workpiece, a blunt tip projecting from the stop for engaging a cable and countersinking it within the workpiece, wherein the tip is adapted to pushing the cable beneath the surface of the workpiece and the stop controls the depth to which the tip penetrates within the workpiece.

In one embodiment the handle is a stick handle. In another embodiment, the handle is a hammer handle or a D-handle. The handle may be removable and replaceable. The stop may be a plate having an area greater than the cross-section of the tip.

In one embodiment, the stop is adjustable, and/or the distance from the stop to the tip is adjustable. In an embodiment the tip is rectangular in cross-section, and/or the tip has an end that has a concave channel for engaging one or more cables. The tip end may also have more than one concave channel to engage more than one cable.

A cable countersink tool is described, having a handle, a rod projecting from the handle, a first arm and a second arm mounted on the rod to form an angle relative to one another, the arms for engaging a cable and countersinking it within an angular workpiece, wherein the first and second arms are adapted to push the cable beneath the surface of the workpiece.

An embodiment has a first stop mounted on the rear of the first arm and a second stop mounted on the rear of the second arm, wherein the stops control the depth to which the first arm and second arm penetrate within the workpiece. The handle may be a hammer handle, a D-handle or a stick-handle, or any number of other handle types.

In an embodiment the first and second arms have a channel for engaging the cable, or may have more than one channel therein for engaging more than one cable. In an embodiment each stop is a plate having an area greater than the cross-section of its respective arm. The angle between the arms may be a right angle, an acute angle or an obtuse angle.

### BRIEF DESCRIPTION OF FIGURES

FIG. 1 is a perspective view of the cable countersink tool, according to one embodiment of the present invention;

FIG. 2 is a perspective view of the cable countersink tool with a hammer handle, according to one embodiment of the present invention; and

FIG. 3 is a perspective view of the cable countersink tool adapted for corners, according to an embodiment of the present invention.

### DETAILED DESCRIPTION

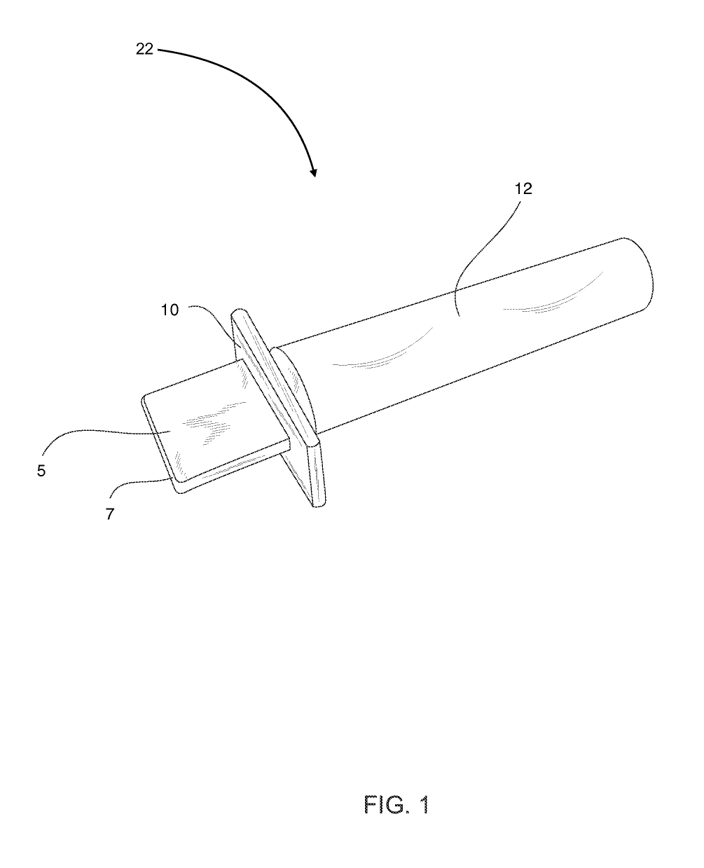

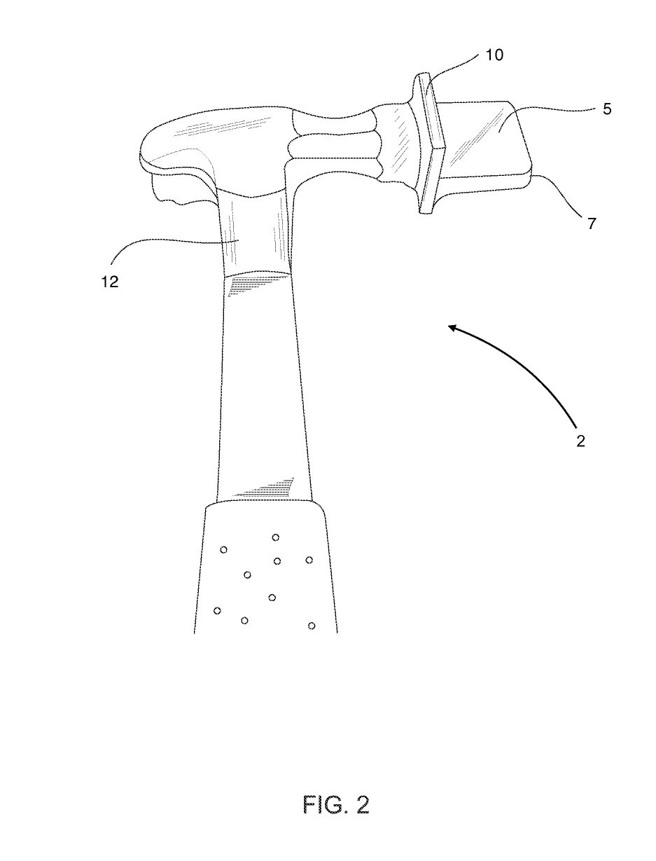

The cable countersink tool 2 is for pushing wire, used for data, phone or electricity for example, or cable, used for multiple purposes including cable TV, data and electricity, for example (both or either of wire or cable referred to simply as “cable” herein) into a workpiece such as insulation, to a pre-determined depth. The tip 5 terminates in a blunt end 7, either squared-off as shown or having one or more concave channels along its length, so to better hold one or more cables to be countersunk. The cables (not shown) sit within the channels as the tip pushes them below the surface of the insulation. A stop 10 consists of a flat plate with an area significantly greater the tip 5. A handle 12 extends from the stop 10, for holding. The handle 12 may consist of a stick handle, as shown in FIG. 1, any number of other angled handles for ergonomics, or a D-handle providing a perpendicular hold, such that the contractor may push in the cable with a punching motion. In a further embodiment, as shown in FIG. 2, the tip 5 and stop 10 are mounted on a hammer handle 12, to facilitate the user's motion of hammering the cable in. The hammer-handled embodiment has the further advantage of catering to a motion familiar to contractors who will perform the countersinking task.

Once the tip 5 has penetrated the insulation, the stop 10 provides resistance when it encounters insulation. The narrow cross-section of the tip 5 allows it to pass through the insulation with little resistance, however the wider area of the stop causes a much greater force pushing back on the handle, so that the user knows, without even looking, that he or she has reached the appropriate depth. The stop 10 has a greater area than the cross-section of the tip 5 in order to provide a greater resistance and signal the user that the desired depth has been reached.

The tip 5 protrudes from the stop 10 a pre-determined depth, which is the length that the cable is to be countersunk, according to building code, for example. In one embodiment, the stop is fixed to the tip 5 so that the depth is non-adjustable. In another embodiment, the position of the stop 10 relative the tip 5 is adjustable for accommodating various depth requirements and materials thicknesses. In one embodiment the stop 10 is mounted on the tip 5 and moves up and down relative the tip 5. In another embodiment the stop 10 may be mounted on the handle 12, so as to move up and down relative to the handle 12 and tip 5.

The tool 2 may be made of any material that is able to withstand the force applied to countersink the cable or wire, including metal, plastic or wood. The entire tool may be from a single piece of metal, welded together for example, or may be a metal tip inserted into a plastic or nylon handle/stop assembly. The handle 12 may be wrapped in a padded or grip material, such as rubber.

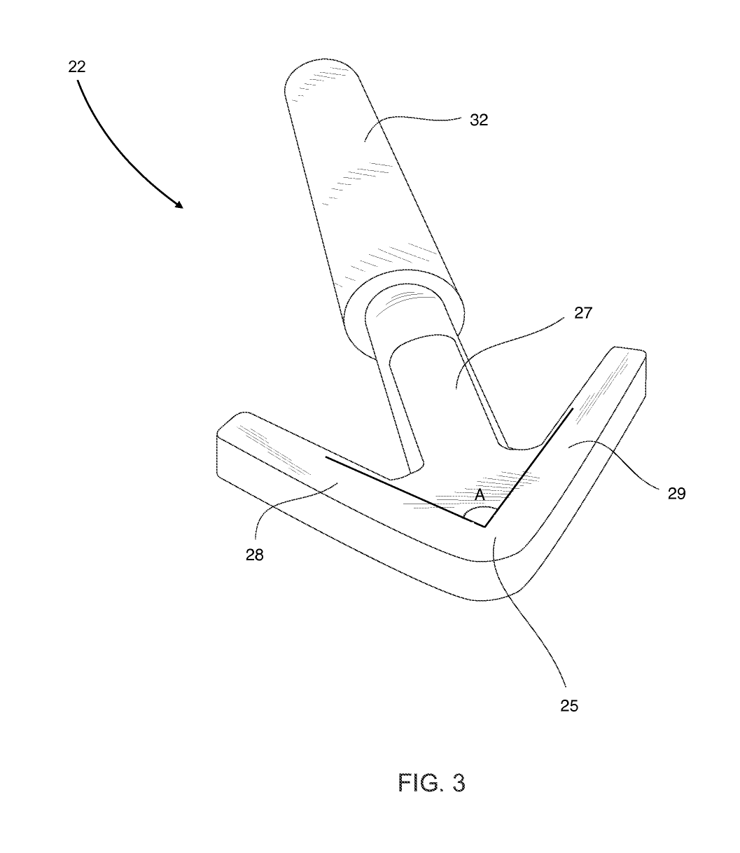

With reference to FIG. 3, a further embodiment for countersinking the cable within insulation where the insulation is angular (for example, it forms a corner) is shown. The tool 22 comprises a tip 25 in an approximately 90-degree configuration (right angle), the tip having a rod 27 protruding from a handle 32. The tip has a first arm 28 and a second arm 29 rigidly disposed from the rod 27, the first and second arms 28, 29 forming an angle A relative to one another, and in this embodiment A is approximately a 90 degree angle. The length of the first arm 28 and second arm 29 are variable depending on the force that is to be applied. The longer the lengths the less force may be applied. The tip 25 is preferably made of a rigid material such as metal or nylon, to withstand the pressures of the force required to countersink the cable (not shown). In another embodiment, a stop 30 (not shown) may be mounted behind each arm 28, 29 such that the arms 28, 29 may only penetrate a given depth into the insulation. Other angles, such as an acute angle or an obtuse angle are possible according to other embodiments, for countersinking cable in corners of 120 degrees or 60 degrees, for example.

The countersink tool is designed to be used by a worker by hand in order to countersink cable within rigid foam insulation, such as Insulated Concrete Forms or polystyrene insulation. In certain embodiments, the tool tip 5 may be implemented on a machine to automate the task of countersinking the cable.

1. A cable countersink tool, comprising
a. a handle;
b. a stop mounted at the end of the handle for providing resistance when penetrating a workpiece; and
c. a blunt tip projecting from the stop for engaging a cable and countersinking it within the workpiece
wherein the tip is adapted to pushing the cable beneath the surface of the workpiece and the stop controls the depth to which the tip penetrates within the workpiece.

2. The countersink tool of claim 1 wherein the handle is selected from the group consisting of a hammer handle, a D-handle and a stick handle.

3. The countersink tool of claim 1 wherein the handle is replaceable.

4. The countersink tool of claim 1 wherein the position of the stop is adjustable.

5. The countersink tool of claim 1 wherein the distance from the stop to the tip is adjustable.

6. The countersink tool of claim 1 wherein the tip is rectangular in cross-section.

7. The countersink tool of claim 1 wherein the tip has an end that has a concave channel for engaging one or more cables.

8. The countersink tool of claim 1 wherein the tip end has more than one concave channel to engage more than one cable.

9. The countersink tool of claim 1 wherein the stop is a plate having an area greater than the cross-section of the tip.

10. A cable countersink tool, comprising
a. a handle;
b. a rod projecting from the handle; and
c. a first arm and a second arm mounted on the rod to form a right angle relative to one another, the arms for engaging a cable and countersinking it within an angular workpiece
wherein the first and second arms are adapted to push the cable beneath the surface of the workpiece.

11. The countersink tool of claim 10 further comprising a first stop mounted on the rear of the first arm and a second stop mounted on the rear of the second arm, wherein the stops control the depth to which the first arm and second arm penetrate within the workpiece.

12. The countersink tool of claim 10 wherein the handle is selected from the group consisting of a hammer handle, a D-handle and a stick handle.

13. The countersink tool of claim 10 wherein the first and second arms have a channel for engaging the cable.

14. The countersink tool of claim 10 wherein the first and second arms have more than one channel therein for engaging more than one cable.

15. The countersink tool of claim 10 wherein each stop is a plate having an area greater than the cross-section of its respective arm.

16. The countersink tool of claim 10 wherein the angle is a right angle.

17. The countersink tool of claim 10 wherein the angle is an acute angle.

18. The countersink tool of claim 10 wherein the angle is an obtuse angle.
